(19) United States
(12) Patent Application Publication
(10) Pub. No.: US 2010/0176147 A1
(43) Pub. Date: Jul. 15, 2010

(54) APPARATUS AND METHOD FOR DISPENSING BEVERAGE

(75) Inventor: Roelof Anton Segers, Bussum (NL)

Correspondence Address: PEARNE & GORDON LLP, 1801 EAST 9TH STREET, SUITE 1200, CLEVELAND, OH, 44114-3108, US

(73) Assignee: HEINEKEN SUPPLY CHAIN B.V., 1017 ZD AMSTERDAM (NL)

(21) Appl. No.: 12/602,376

(22) PCT Filed: Jun. 2, 2008
(86) PCT No.: PCT/NL08/50338

§ 371 Date: Mar. 16, 2010

(30) Foreign Application Priority Data
May 31, 2007 (NL) 1033915

(51) Int. Cl. B67D 7/00; B67D 1/07; B67D 7/80; B67D 7/86; B67D 7/74

(52) U.S. Cl. 222/1; 222/148; 222/146.6

(57) ABSTRACT

An apparatus for dispensing beverage, comprising a line system and at least one draw-off tap and a connecting head connected to said line system, and a connecting piece provided with means for connection to said connecting head to be connected to a beverage holder, wherein the line system comprises at least a rinsing line and a dispensing line and the connecting head comprises at least a valve device for connecting the dispensing line to, at will: the connecting piece, or at least to a holder, for fluid communication between a holder and the tapping line; or the at least one rising line for fluid communication between the respective rinsing line and the dispensing line.

The invention relates to an apparatus for dispensing beverage. In particular, the invention relates to an apparatus for dispensing beverage comprising a line system and at least one draw-off tap.

For dispensing beverage in, for instance, hotels, restaurants and bars, usually, a tapping device with a line system and a draw-off tap, for instance on a tapping column, connected thereto and arranged on a bar is utilized. The tapping line extends beyond the bar, for instance as far as into a cellar space, where a connecting head is provided with which the tapping line can be connected to a holder for beverage, for instance a beer cask, such as a keg or a cellar beer holder, such as a relatively large bag-in-container type holder with a content of, for instance, more than 750 or 1,000 liters. Usually, such apparatus are indicated as cellar beer installations, although the bag-in-containers designed as tanks can also be arranged in another space than a cellar and also, other beverages can be stored therein.

For known cellar beer installations, it holds that for filling the apparatus, an inner bag is removed from the holder and is replaced with a new one, when the inside bag is empty. To that end, the tapping line, for instance a Python with integrated cooling, is uncoupled from the holder and is coupled to a rinsing line so that a rinsing liquid can be fed through the tapping line, which is carried off via the draw-off tap. Such a cleaning operation is, for that matter, performed regularly, also when the holder is not empty yet. After cleaning with rinsing liquid, clean water is fed through the tapping line, for removing all remainders of rinsing liquid, since, for instance, soap, lye and other chemicals can be present therein which may influence the taste of the beverage to be disposed or may otherwise be harmful. The connecting head with which the tapping line is coupled to the holder and in particular a connecting bend used there are to be cleaned separately. To that end, upon filling the holder, the used connecting head is replaced and the used connecting bend is replaced with a new connecting bend cleaned in, for instance, the brewery or by a cleaning service. In order to start, monitor and terminate a cleaning cycle, a user of the system or a cleaning service engaged to that end are to go to the holder, perform the operations mentioned and finally reconnect the system again. This is time-consuming and expensive. Furthermore, checking the process is difficult.

The object of the invention is to provide an apparatus for dispensing beverage, which is practical in use.

In a first aspect, an apparatus according to the present invention has a line system and at least one draw-off tap and a connecting head connected to said line system, and a connecting piece provided with means for connection to said connecting head to be connected to a beverage holder, wherein the line system comprises at least one rinsing line and one dispensing line and the connecting head comprises at least one valve device for connecting the dispensing line to, at will, the connecting piece, at least to a holder for fluid communication between a holder and the tapping line, or the rinsing line for fluid communication between the rinsing line and the dispensing line.

With such an apparatus, by setting the connecting head, in particular the valve device, a switch can be made between a first position, wherein a cleaning cycle of the tapping line can be performed, and a second position wherein beverage can be fed from a holder to the draw-off tap, via the tapping line. To that end, the tapping line and the rinsing line need not be uncoupled, neither from each other, nor from the holder.

Preferably, the valve device is provided with means for remotely operating it, for instance from adjacent the draw-off tap. To that end, for instance an electrical, hydraulic or pneumatic drive of the valve device can be provided. Preferably, the valve device comprises a multi-way valve such as a three-way valve.

In a second aspect, an apparatus according to the invention can be provided with a series of connecting heads, mutually connected by one or more intermediate lines. Depending on the position of the valve devices of connecting heads foremost in flow direction of the line system, the intermediate line(s) can form part of the tapping line or of the rinsing line. The holders or at least the connecting heads can then be connected in series. During use, it is preferred that first, the holder located the farthest from the draw-off tap in flow direction will be switched on for dispensing beverage therefrom, to which end the valve device connected thereto is brought into the second position, while the valve device of the remaining connecting heads is brought into the first position, so that no beverage can be dispensed from the holder connected thereto and beverage can be introduced via the intermediately connected intermediate lines into the tapping line. If a first holder in such an apparatus is empty or no more beverage can or should be supplied therefrom to the at least one draw-off tap for any other reason, the valve device of a connecting head successive in flow direction can be switched from the first to the second position, so that therefrom, beverage can be introduced into the tapping line and the passage from the preceding first holder is closed off, in particular by the valve device. In a rinsing cycle, all mutually connected valve devices will be brought into the first position, so that rinsing liquid can rinse and clean all these connecting heads and intermediate lines, the rinsing line and the tapping line, as well as the at least one draw-off tap. Series of connecting heads can also be parallel connected, or combinations of parallel and in series.

Such an apparatus offers the advantage that in a cleaning cycle, connecting heads connected in series and lines are cleaned. What can be prevented is that a part of the apparatus can be cleaned while beverage is still being dispensed. Such an apparatus is safe, also when an automatic cleaning cycle is performed. Moreover, such an apparatus is easy to use.

If in such an apparatus, the valve devices are remotely operable, switching from one holder to the other holder for dispensing beverage from, for instance, adjacent the draw-off tap can be regulated, instead of moving one connecting head from a first to a second holder, as is done with the conventional cellar beer installations.

In an apparatus according to the invention, several holders can be utilized, which each can be of the same type or of different types. Cellar beer holders with a relatively large volume, for instance more than 750 or 1,000 liters, as are customarily used, can be combined in the apparatus with smaller holders, for instance between 100 and 500 to 750 litres and/or with kegs with a still smaller content, for instance between 10 and 50 litres, as are already used with tapping devices. As a result, a large flexibility is obtained, both in amounts of beverage held in stock and in types of beverage that can be dispensed.

In a third aspect, an apparatus according to the invention can be provided with an electronic regulator device, wherein in or on the rinsing line, a flow meter is included with which during a cleaning cycle, the flow of rinsing liquid and/or water through the rinsing line can be measured. It is moreover preferred that a display is provided, preferably adjacent the at least one draw-off tap, from which the flow can be read and/or on which an alarm can be produced when during a cleaning cycle, the flow falls below a set minimum threshold value. The fact is that this may mean that the at least one or, with several draw-off taps, at least one of the draw-off taps is closed, an obstruction has occurred in the line system, a connecting has been brought into the wrong position or the through-flow in the at least one part of the line system is otherwise blocked, so that cleaning cannot be carried out properly, or at least not optimally. Optionally, an alarm could also be produced if the flow exceeds a desired maximum threshold value, because then, a leakage may have occurred. Such a regulator device enables relatively simply a substantially automatic cleaning of the apparatus, which can preferably be driven and checked from adjacent the draw-off tap or draw-off taps. The safety can be guaranteed in a simple manner, while each time the type of liquid in the apparatus and/or parts thereof can be determined or checked.

In a fourth aspect, an apparatus according to the invention can be provided with a holder in which beverage is included, wherein cooling means are provided for cooling this holder, which cooling means enclose at least one connecting head connected to the holder.

By cooling the connecting head during use of the apparatus, the quality of the beverage is prevented from being adversely influenced because for instance in or on the connecting head an undesired microclimate is formed wherein the temperature rises above a desired temperature, so that for instance the taste and hygiene of the beverage could be affected. Furthermore, the temperature of the beverage can thus be regulated even better, in particular if also the tapping line and any intermediate lines are cooled. To that end, they can be designed in a python-like manner, such as cooled lines, known as python or (cooled) trunk lines, supplied by, for instance, MicroMaticInc, USA.

In a further aspect, the invention is characterized by a holder in which a part of the tapping apparatus can be placed at least temporarily, wherein UV-light generating means are provided with which at least a part of said part is radiated when it is placed in and/or on the holder.

Preferably, an apparatus according to the invention is provided with means for measuring the content of a holder for beverage connected to the apparatus or forming part thereof, or at least the remaining volume of beverage. With it, each time, from the respective holder and preferably from each holder on or in the apparatus, the remaining amount of beverage can be determined, so that for instance stock control and switch from one holder to another holder can be simply arranged, in particular according to the FiFo principle, so that each time, the freshest beverage will be dispensed only when earlier stored beverage is finished, especially when it is of the same type. In particular if this information is represented on, for instance, a display adjacent the or a draw-off tap and/or is passed on to, for instance, a brewer or distributor of the beverage. It is preferred that sensors are used for measuring the content, which are simple and do not contact the beverage, for instance thermal sensors provided in or against the holder, for instance sensors provided in series one above the other.

An apparatus according to the invention is preferably of modular design, so that it can simply be adapted to the wishes of a specific user, while the apparatus can each time be adapted to changing needs. To that end, it is preferred that use is made of an electronic regulator device, which can be designed as module, provided with a connector system in which modules can be coupled. Preferably, at least one tank module, a regulating module, a cleaning module and a tapping module are provided, while additionally, a cooling module and a pressure module can be provided.

The invention further relates to a method for the use of a beverage dispensing apparatus which, in a first aspect according to the invention, comprises a cleaning line, a tapping line and a draw-off tap, wherein the cleaning line is coupled via a connecting head to the tapping line and to a holder for beverage, which connecting head comprises a three-way or multi-way valve and drive means thereto, which is driveable with the aid of a regulator device with operating means at a distance from the connecting head. When starting a cleaning cycle, the three-way or multi-way valve is brought from the first position, wherein the tapping line is in fluid communication with the holder, to a second position wherein the tapping line is in fluid communication with the cleaning line, while the at least one draw-off tap is opened and liquid is introduced through the cleaning line through the connecting head and in particular through the three-way or multi-way valve into the tapping line, while displacing beverage from the tapping line through the draw-off tap. Then, during a first period, rinsing liquid can be fed through the rinsing line and the tapping line, carried off via the at least one draw-off tap. After that, during a second period, water can be fed through the rinsing line and the tapping line for removing the rinsing liquid from the tapping line, whereupon the at least one three-way or multi-way valve is returned to the first position and the draw-off tap is closed and then, water having remained behind in the tapping line is displaced from the tapping line with the aid of beverage from a holder connected to the three-way or multi-way valve. Naturally, a three-way or multi-way valve can also be built up from a series of two-way valves.

Such an apparatus enables cleaning of the apparatus in a particularly simple manner, and switching between different holders when these are connected to the apparatus.

In clarification of the invention, exemplary embodiments thereof will be explained in further detail on the basis of the drawing. In the drawing:

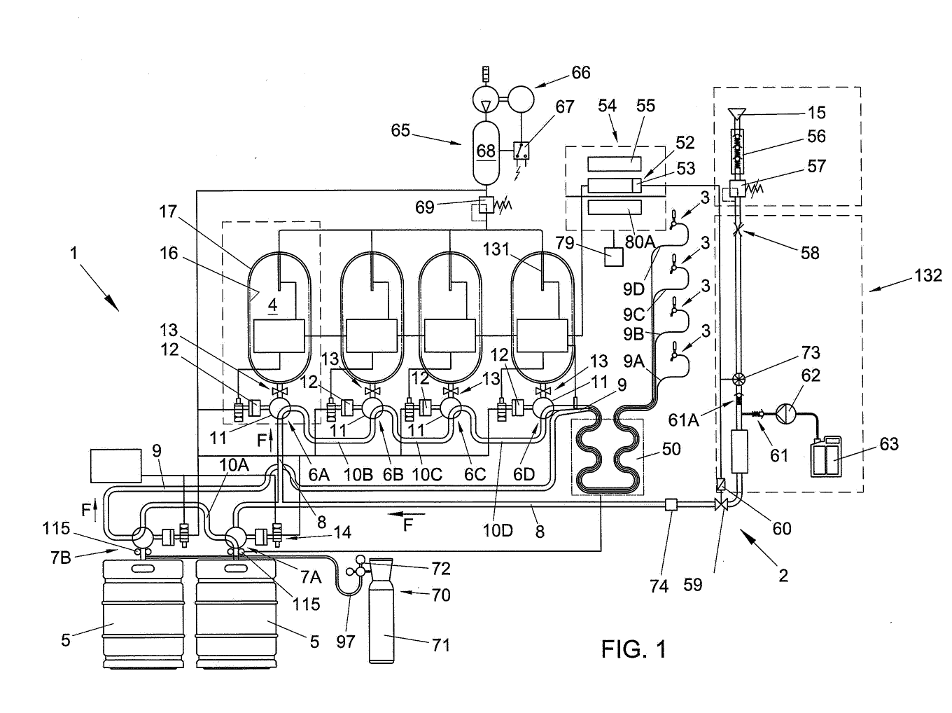

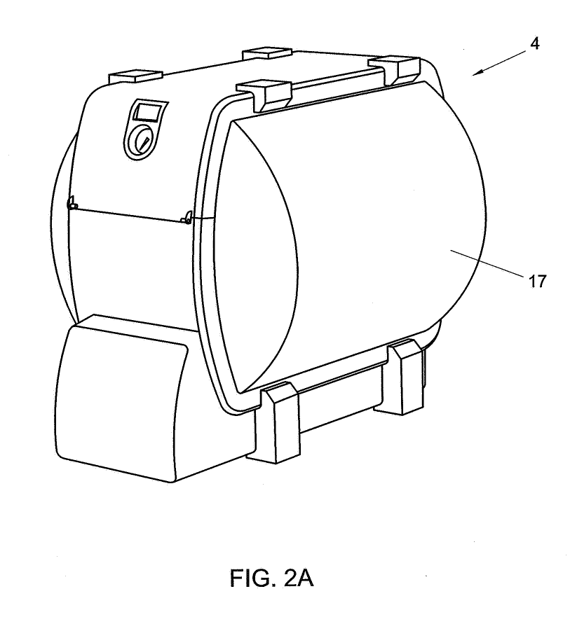

FIG. 1 schematically shows an embodiment of a tapping apparatus;

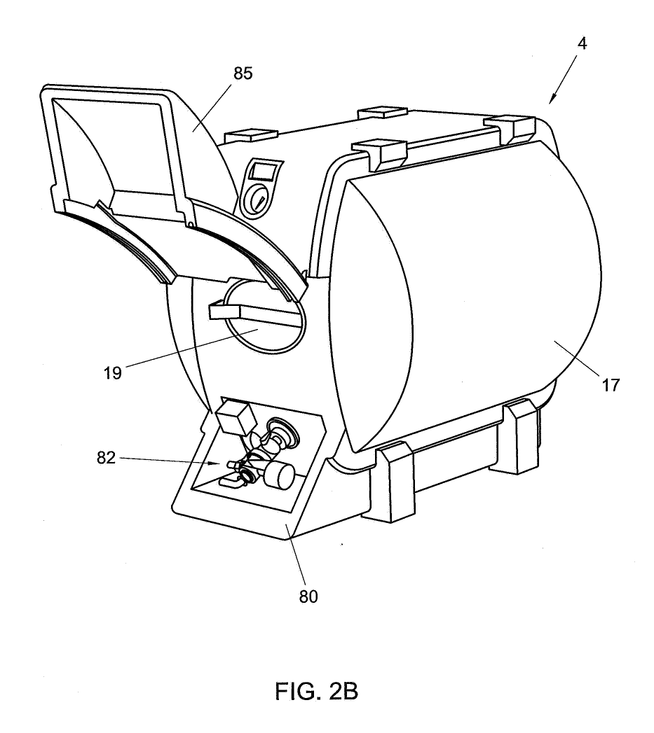

FIGS. 2A-B show in closed and partly open condition, in perspective view, a holder for use with a tapping apparatus;

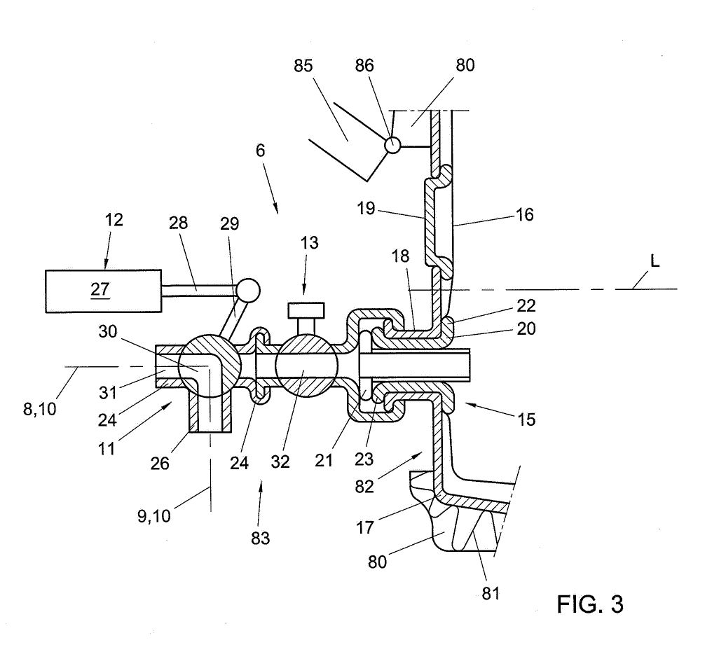

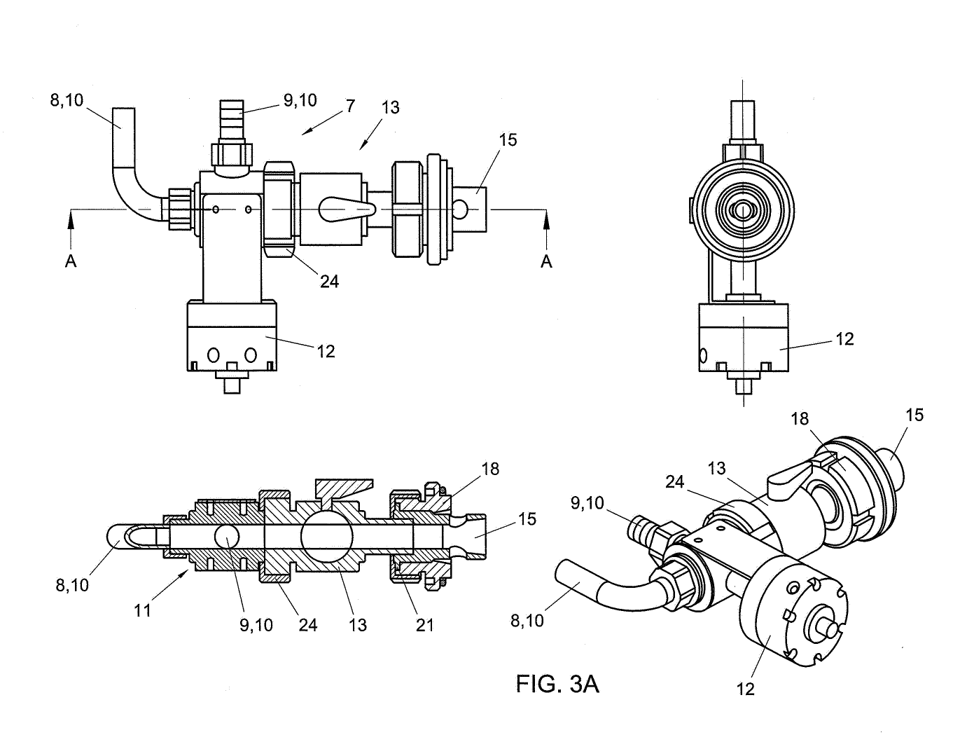

FIG. 3 schematically shows a connecting head;

FIG. 3A shows an alternative embodiment of a connecting head;

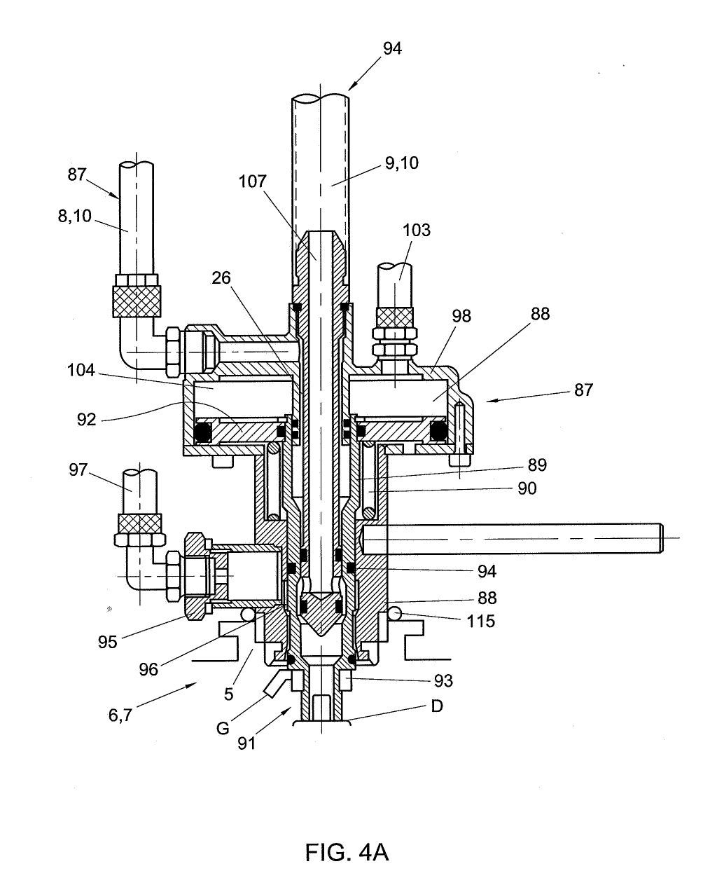

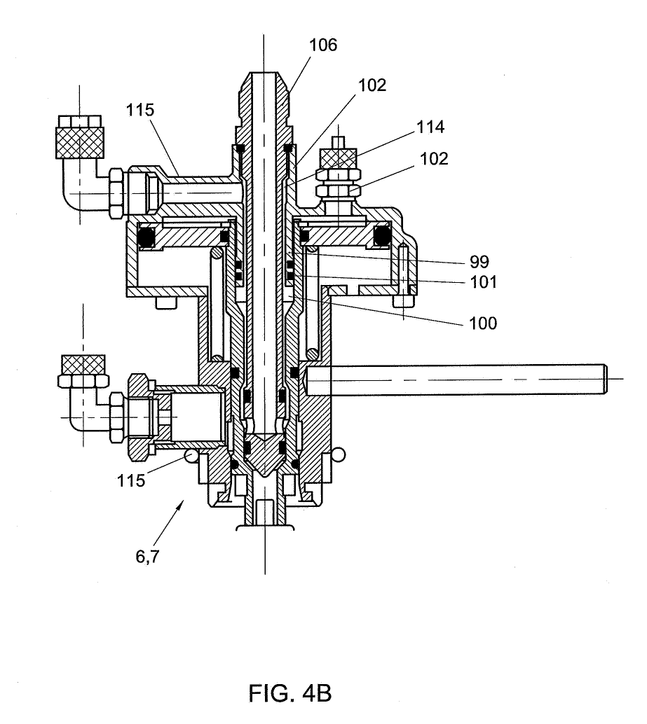

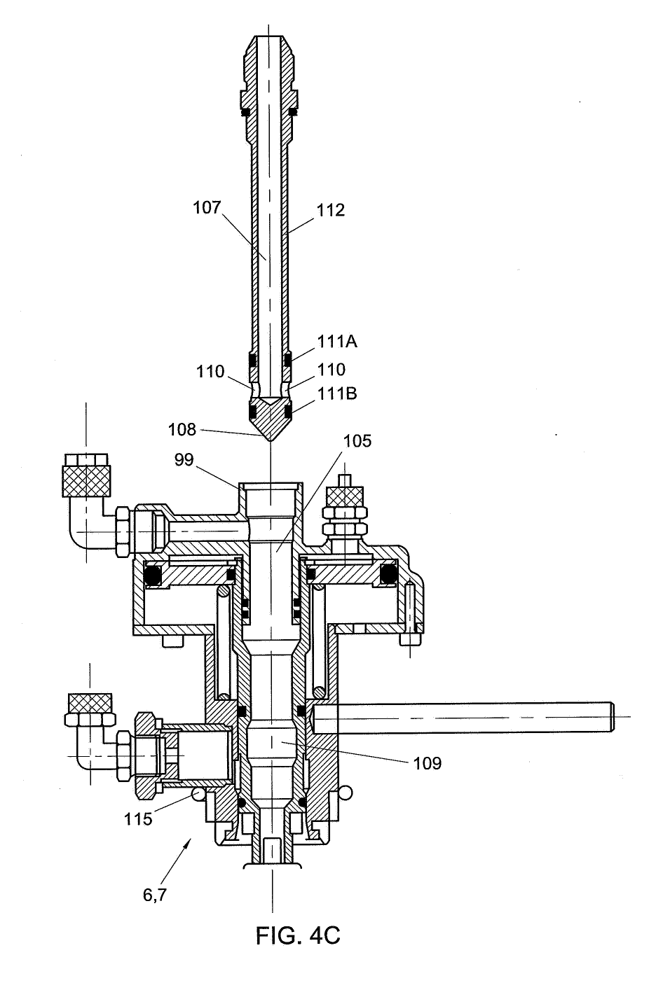

FIGS. 4A-C schematically show, in cross-sectioned views, an alternative embodiment of a connecting head according to the invention, in particular suitable for kegs; and

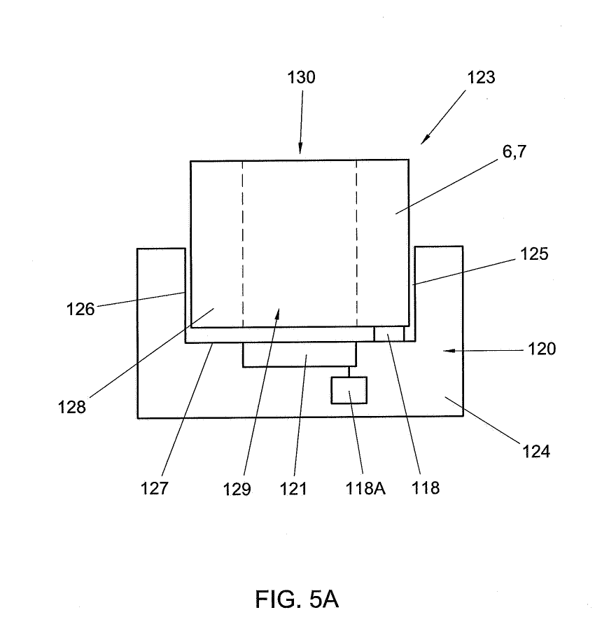

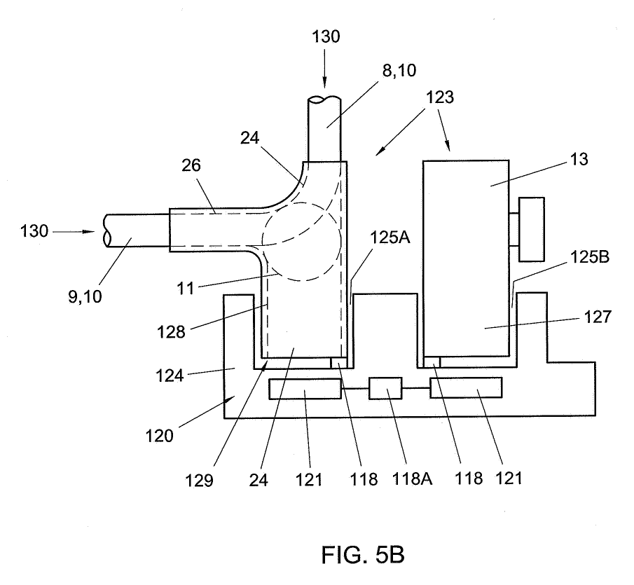

FIGS. 5A and 5B show two alternative embodiments of holders for tapping heads.

In this description, identical or corresponding parts have identical or corresponding reference numerals. The embodiments shown are shown merely by way of illustration and should not be construed to be limitative in any manner. In this description, apparatuses and parts thereof will be described on the basis of an apparatus for dispensing beer. However, an apparatus or parts thereof can also be used for dispensing other types of beverage, such as soft drink or wine.

In FIG. 1, schematically, an apparatus 1 according to the invention is shown, comprising a line system 2 and a series of draw-off taps 3. In the exemplary embodiment shown, four draw-off taps are represented, but in principle, any number of draw-off taps 3 is possible. Further, four other holders 4 are shown, in particular of the bag-in-container (BIC) type as known from, for instance, the known cellar beer apparatuses or a BIC as will be described in further detail on the basis of FIG. 2, and two smaller holders in the form of kegs 5. The different parts are not represented to scale. Other combinations of types of holders are possible too.

Each holder 4 is couplable with the aid of a first type of connecting head 6 to the line system 2, while the holder 5 is also couplable to the line system 2 via a second type of connecting head 7. In the embodiment shown, viewed in flow direction F of the line system 2, the kegs 5 are arranged parallel to the holders 4 and coupled to the line system 2. However, this can be done in any random order, both parallel and in series or combinations thereof. The line system 2 comprises a rinsing line 8, a tapping line 9 which, in the example shown, is partly divided in a manner to be further described, into four sub tapping lines 9A-D and five intermediate lines 10A-E, which will be described in further detail.

Each connecting head 6 of the first type comprises a shutoff 13, a three-way valve 11 and operating means 12 for the three-way valve 11, which, together therewith, can be indicated as three-way valve device. In the exemplary embodiment shown, the operating means 12 are pneumatic means but can also be of other design, for instance electric or hydraulic. With the aid of the operating means 12, the three-way valve 11 is operable between a first and a second position, as will be described in further detail. The or each second type of connecting head 7 is designed, for instance, as shown in FIG. 3 or 4 and will be further described. This connecting head 7 can also be switched between a first position and a second position with the aid of operating means 14, as will be described in further detail. This connecting head 7 may be designed as a known changeover keg head as known from EP 023547 or U.S. Pat. No. 3,878,970.

The shutoff 13 and the three-way valve 11 may be combined into a four-way valve so that filling, cleaning and dispensing beverage is possible through the same multi-way valve. Optionally, a multi-way valve with more entrances and exits can be utilized, for instance for parallel connection of a number of kegs and/or other containers, for forming a bypass or the like.

The rinsing line 8 extends between an inlet combination 132 connected to a water connection 15 and the first connecting head viewed in flow direction F, in the embodiment shown connecting head 7A, and via a branch the first head 6A. A tapping line 9 extends from the rearmost connecting head 7A, viewed in flow direction F, and rearmost connecting head 6D and connects these, via the sub-tapping lines or intermediate lines 9A-D, to the different draw-off taps 4A-D. Preferably, the sub-tapping lines 9A-D and/or the tapping line(s) 9 extend partly through a through flow cooler 50 and can furthermore be of cooled design, for instance as a python. The intermediate line 10A connects the tapping head 7A, foremost in flow direction F, to the second 7B, while the second tapping head 7B is connected to the tapping line 9, while the intermediate lines 10B-10C connect the third tapping head 6A to the fourth tapping head 6B, the fourth tapping head 6B to the fifth tapping head 6C, and the fifth tapping head 6C to the sixth tapping head 6D, respectively. It will be clear that other numbers of kegs and/or tanks can be utilized too, in a line circuit with one or more flow paths. Only the tapping line, intermediate lines 10B-D and the rinsing line may suffice too, i.e. without the kegs, or, conversely, just kegs and no tanks, with no branch or, conversely, several branches for separate circuit parts. For the tanks and kegs or other containers, also, separate draw-off taps may be provided, connected to different tapping lines.

In FIGS. 2A and B, in perspective view, a holder 4 is shown, in the form of a tank. The tank 4 as shown is designed as a bag-in-container type tank, comprising an outer container 17, an at least partly flexible inner container 16 included therein, and a casing 80 enclosing the outer container. The casing may be provided with a thermal insulating layer 81. Here, the tank is shown to be substantially cylindrical, with a longitudinal axis L extending horizontally, wherein on a front side an opening 82 is provided in the casing 80. In this opening 82, filling and dispensing means 82 are represented, which will be described in further detail on the basis of FIG. 3. Above the filling and dispensing means 83, in the opening 82 a hatch 19 is visible, that can be opened in order to remove an inner container 16 from the outer container and to place a new one.

Over the opening 82, a cover 85 is provided, hingedly connected to the casing 82 by a pivot 86 above the opening. The cover 85 can cover the opening 82 completely in closed position (FIG. 2A) and release it completely in opened position (FIG. 2B). As the cover 85 can completely cover the opening, influence from outside the tank 1 is reduced to a minimum. For instance, contamination is prevented, the space under the cover can be kept cool and the connecting device is protected from, for instance, blows, impacts and the like.

In the exemplary embodiment shown, the space that is enclosed by the cover 85, when this is closed, is cooled as a result of the cooling of the outer container 17 and an insulating action of the cover 85. To that end, the cover 85 can be provided with an insulating layer. This cools the filling and dispensing apparatus and the hatch. Owing to this cooling to, for instance, a few degrees above zero, for instance between 0 and 10 Centigrade, more particularly between 2 and 6 degrees Centigrade, a favourable microclimate is created and maintained, so that bacterial growth is largely prevented. As a result, less frequent cleaning of the installation is required, which is advantageous for management of the apparatus. Furthermore, the risk of contamination of the beverage is considerably reduced. Further, it is of energetic advantage.

In FIG. 3, schematically, in partly cross-sectioned side view, a connecting head 6 of the first type is shown, comprising the three-way valve 11 with operating means 12, the shutoff 13 and the connecting piece 15. Furthermore, schematically, a portion of the holder 4 is shown, in which are visible the inner container 16 with a filling opening, inserted into a neck 18 of the outer container 17 of the holder 4, which outer container is manufactured from, for instance, metal, while the inner container 16 is bag-shaped and at least partly flexible, with an insertion neck 22 which is provided at a free end with a flange 23 projecting outwards. The outer container 17 is provided with a hatch 19 through which the inner container 16 can be inserted into the outer container 17 or be removed therefrom. When placing, the inner container is inserted through the hatch 19 and then the insertion neck 22 is pressed back outwards through the neck 18, so far until a flange 23 of the filling opening comes to lie against the outside of the neck 18. This is known per se from cellar beer installations. The connecting piece 15 is substantially straight and relatively short. It has a substantially straight inner channel 20 with, on one end, a flange 21 projecting outwards and an outer diameter which approximately corresponds to the inner diameter of the neck, less approximately twice the thickness of the material reaching into the neck of the inner container. This means that this material is held against the inside of the neck 18 by the connecting piece 15, while the flange 21 rests against the end face of the heck, against the flange 23 of the inner container 16.

The shutoff 13 is included between the three-way valve 11 and the connecting piece 15 or at least the neck, when the shutoff is fastened on the neck 18. As a result, the three-way valve 11 can be detached in a simple manner, so that the inner container can be filled therethrough, while the shutoff with the connecting piece 15 can simply be removed, when the inner container 16 is empty, so that it can be cleaned. Cleaning is possible in a simple manner, in that the parts are all substantially straight, at least passages thereof, and have no wasted or empty cavities that come into contact with the beverage. Preferably, these are as short a possible for further simplification of cleaning. A bracket can be provided, on or at the tank, for temporarily receiving the valve or valves, so that cleaning is simple. For the, a or each three-way valve 11 it holds that it is attached by first stub 24 on the shutoff 13, by a second sub 25 on a feeder line, which is either the rinsing line 8 or an intermediate line 10, while a third stub 26 is connected to an intermediate line 10 or the or a tapping line 9. By switching the operating means 12, represented in this embodiment in a simplified manner as a pneumatic cylinder 27 with piston rod 28, with which, via a lever 29, a ball 30 can be rotated with a curved passage, the shutoff is brought into a first position, wherein the passage 32 of the shutoff 13 is connected to the discharging line 9, 10 which is connected to the third stub 26, or in a second position wherein the feeder line 8, 10 which is connected to the second stub 25, is connected to the discharging line 9, 10 which is connected to the third stub. By closing the shutoff 13, the passage 20 is closed off and no beverage can be dispensed from the inner container 16 and no rinsing liquid or beverage be introduced therein.

In FIGS. 4A-C, three positions are shown of a connecting device or connecting head 6, 7. Here, the beverage dispensing line or tapping line 9 or intermediate line 10, container 5 and rinsing line 8 or intermediate line 10 are represented only partly and schematically. It is merely an example of a connecting head 6. Many variations are possible. The connecting head 6, 7 as shown comprises a housing 87 with a first stub 88, with which it can be coupled to a keg 5, directly above a beverage valve D thereof. On a side of the housing 87 remote from the first stub 88, a widening 88 is provided. A piston rod 89 extends through a central bore 90 into the housing 87 and is provided on a first end, adjacent the first stub 88, with a connecting nose 91 with a first gasket 93 for sealing around a beverage valve, for separating a beverage stream and a gas stream. On a second end, the piston rod is connected to a piston 92 which is movable in the widening. Between the piston 92 and the gasket 93 a second gasket 94 is provided which abuts against the inside of the bore 90 and seals of in a gastight manner. A fourth stub 95 links up with a slit-shaped space 96 between the bore 90 and the part of the piston rod below the second gasket 94. A gas supply line 97, for instance a CO2 line, is connectable to the fourth stub 95, for introducing gas via the fourth stub 95, the slit-shaped space 96 to an inner space of the keg 5, along a gas valve G. By moving the piston downwards in the widening 88, in the direction of the keg 5, the connecting nose is pressed against the beverage valve D, thereby opening this and the gas valve G.

The widening 88 is closed at a top side by a closing part 98, which is provided with a bush 99 that fits within a widening 100 of the piston rod 89, wherein third gaskets 101 are provided between the widening 100 and the piston 92 and/or piston rod 89, so that a sliding sealing is obtained. In the closing part 98, a fifth stub 102 is provided to which a gas supply line 103 is connectable, for introducing into the space 104 above the piston 92 an operating pressure for operating the piston and hence opening the beverage valve and the gas valve.

Through the bush 99, the piston rod 89 and the closing part 98 extends a passage 105, which is straight here, and continues as far as into the connecting nose 91. During normal use, through the passage 105, a sealing rod 106 extends which rod is substantially hollow-cylindrical, with a central channel 107 and a closed first end 108 directed towards the connecting nose. The sealing rod 106 fits in the passage 105 with little clearance. Adjacent the connecting nose 91, the passage 105 is provided with a widening 109. The sealing rod is provided adjacent the closed end 108 with inlet openings 110, placed, for instance, diametrically opposite each other. On both sides of the inlet openings 110, a gasket 111A, 111B is provided around the sealing rod. In the tapping position shown in FIG. 4A, the upper gasket 111A seals against the inside of the passage 105, while there is a space between the lower gasket 111B and the passage, so that beverage can flow from the keg 5 via the inlet openings into the channel 107, in the direction of a second connecting stub 112 formed by the top end of the sealing rod 106. A tapping line 94 can link up with this second connecting stub 112. In the rinsing position in FIG. 4B, the lower second gasket 111B seals against the inside of the passage 105, below the widening 109. The purpose hereof will be explained further.

The sealing rod 27 seals at the upper side against the bush 99. Between the part of the passage 105 in the bush 99 and the sealing rod 105, a slit-shaped space 114 is provided. A third stub 115 links up with this space, to which stub a rinsing line 8 is connectable. In the rinsing position shown in FIG. 4B, rinsing liquid can be fed from the rinsing line 8 via the slit-shaped space 114 to the inlet openings 110, wherein the gasket 111B prevents liquid from flowing further in the direction of the keg 5. The liquid flows via the inlet openings 110 into the channel 107 and thence into the beverage dispensing line. If at least one draw-off tap 3 that is connected to the beverage dispensing line or tapping line 9 is opened, the liquid can flow away through this draw-off tap 3, and the line circuit 2 comprising this connecting device 6, 7 can be cleaned. Here, the piston 92 is pushed back upwards by the spring pressure of the beverage valve D, so that no more gas can be pressed into the container, or can escape therefrom.

In FIG. 4C, it is indicated that the sealing rod 106 can simply be pulled from the passage 105.

As clearly appears from these Figures, rinsing liquid will not come as far as the beverage valve, the lower part of the passage will always come and remain in contact with beverage. In order to protect at least this part from undesired bacterial growth, with this connecting device, a cooling line 115 is provided which extends around the connecting device and in particular around the part of the housing 87 extending around the lower part 116 of the passage 105, adjacent the connecting nose 91. During use, cooling medium is fed through the cooling line 115, in the exemplary embodiment shown cooled water. To that end, the cooling line 115 is connected to an in-line cooler through which also the beverage dispensing line can be fed. The cooling line 38, 115 and in particular the cooling medium has a temperature such that the respective lower part of the connecting device 6 is cooled to below 15° C., preferably to below 10° C. In the case of beer, it is advantageous when the temperature is maintained at approximately 6° C. As a result, the beverage in the connecting device is always brought to and maintained at a desired, low temperature, so that growth of bacteria is prevented or is at least delayed. In known tapping devices, usually the container, such as the keg 5, is cooled. By cooling the dispensing device and utilizing an in-line cooler for the beverage dispensing line, cooling of the container may, if required, be omitted, which, from a standpoint of energy and costs, is advantageous.

As appears from FIG. 1, the operating means 12, 14 of the connecting heads 6, 7 are connected to a central regulator device 52, preferably an electronic regulator unit, such as a drive unit with processor 53 and interface 54, such as a touch screen 55. In the rinsing line 8, between the water connection 15 and the first connecting head 6A, an inlet combination 132 with safety control 56 in the form of a three-way KIWA safety are provided, to prevent rinsing liquid or polluted water from flowing back into a (public) water mains (not shown), a reducing valve 57, an adjustable throttle 58, a water valve 59, preferably provided with drive means 60, such as electric drive means for opening, closing and regulating these, and a connection 61 for a pump 62, in particular a dosing pump such as a membrane pump or a hose pump for dosing cleaning agent, such as a lye, from a storage tank 63. The water valve 59 is preferably arranged such that no cleaning liquid can be drawn from the storage holder 63 if reduced pressure occurs in the rinsing line, for instance in case of a water shock. At least the drive means 60 and the dosing pump 62 are connected to the regulator device 52. Between the connection 61 and the pump 62, preferably, a non-return valve 64 is provided. A measuring device 74 can be provided with which a parameter of the rinsing liquid or at least a liquid in the rinsing line or elsewhere in the line circuit can be measured, in order to determine whether this liquid is “clean” water or rinsing water with, for instance, a soap, lye or other cleaning agent. To that end, the sensor 74 can for instance be or comprise a conductivity sensor. Other sensors too can be utilized, such as for a pH measurement, color measurement and the like.

Supply means 65 for supply of pressure gas, such as compressed air are provided, comprising a compressor 66 with control 67, a buffer tank 68 and reducing valves 69, connected to the tanks 4 such, that pressurized gas can be introduced between the outer container 17 and the inner container 16. Preferably, the reducing valves maintain the pressure on the inner container at a desired excess pressure, so that each time a desired tapping pressure is obtained. For the kegs 5, a gas supply device 70 can be provided, for instance a known CO2 bottle 71 with reducing means 72. With it, the beverage in the kegs 5 can be pressurized.

In the position shown in FIG. 1, the first connecting head 7A is brought into a first position, with the aid of the regulator device 52, while the inner space of the keg 5 is connected to the intermediate line 10A. The other connecting head 7B has been brought, by the regulator device 52, into the second position such that the intermediate line 10A is connected to the respective tapping line 9. Beverage can thus be brought from the keg 5 via the intermediate line 10A and the tapping line 9 to the sub-tapping lines 9A-D and thence be dispensed via one or more draw-off taps 3. The connecting heads 6A-D are set such that therethrough neither rinsing liquid nor beverage can flow to the draw-off taps 3 and/or in the opposite direction. To that end, the first 6A of these four tapping heads may be brought into the tapping position, while no pressure is applied to the respective inner container. The shutoffs 13 can also be brought into the closed position, in particular when they are designed to be remote-controlled. When the first keg 5 is empty or there is no need to otherwise tap therefrom, with the aid of the regulator device 52, the first connecting head 7A can be brought into a third position, in which the rinsing line 8 is shut off, as is the keg 5. The second connecting head 7B is brought into the first position, so that beverage can be dispensed from the second keg 5 to the draw-off taps 4. By broaching, for that matter, the second keg by bringing the connecting head 7B into the first position, it can be ensured that beverage flows only to the draw-off tap, when the first connecting head 7A is in the second position or rinsing position. When this keg is empty, or there is no need to otherwise tap therefrom, this second shutoff is brought into the third position, so that no further beverage can flow from the keg 5, while the third connecting head 6A is brought into the first position. Then, beverage can be brought from the first holder 4 into the tapping line 9, via the intermediate lines 10B-D. Eventually, when the first holder 4 is empty or needs to be closed, the respective connecting head 6A is brought into the second position and the fourth connecting head 6B is brought into the first position, so that beverage can be dispensed from the holder 4 connected thereto, and thus further to the third tank and the fourth tank, until, for instance, all thanks and/or kegs have been emptied.

The order of use of the kegs and holders, for that matter, can also be selected differently. The connecting heads 6, 7 can be connected in any desired order.

In the regulator unit 52, data are kept up to date about the beverage included in the kegs and/or holders 4, such as type, filling, date of filling or best-before date and the like. In the regulator unit, a program is included with an algorithm which determines on the basis of these data and/or instructions of, for instance, the brewer or manager, when for instance the line system is to be cleaned. This can be indicated on, for instance, the interface, such as the touch screen 79. A manager can commence a cleaning cycle, preferably after having entered a PIN-code or having activated the system in another manner, by pushing a suitable (virtual) button on the touch screen 79. The PIN-code or such identification can prevent unauthorized use. Then, the regulator unit will bring at least tapping heads 6, 7 into the first second position, such that the rinsing line 8, the intermediate lines 10A-D and the tapping line 9 are in communication with sub-tapping lines 9A-9D. Then, during a first period, first, water will be supplied from the water connection 15, with which the remaining beverage can be displaced from the intermediate lines 10A-D and/or (sub) tapping lines 9, 9A-D, by opening the taps 3. When all beverage has been displaced, during a second period, water with a desired amount of cleaning agent will be fed, dosed by the dosing pump 62, through the line system 2, measured and/or checked by the measuring device 74.

In the rinsing line 8, preferably, a flow sensor 73 is included, with which the flow in the rinsing line 8 and hence in the entire line system 2 can be accurately checked. It is preferred that in the regulator unit 52, an initiation program is included, in which a manager can input, preferably in an interactive manner, the layout of the tapping device 1, for instance data about the total content of the line system and the number of draw-off taps. On the basis of the data inputted by the manager or, for instance, an installer, the processor determines a minimum and maximum flow value. During cleaning of the line system, the draw-off taps 3 should all be open, in order to ensure that all tapping lines, in particular sub-tapping lines 9A-D and draw-off taps 3, are cleaned according to a preselected protocol. By measuring with the flow sensor whether the flow in the rinsing line 8 is within the boundaries mentioned, it is ensured that the protocol is followed. If the flow falls below the minimum flow value, the interface 54 produces an alarm signal, for instance audible or visual. Then, the manager knows that the cleaning cycle has not proceeded properly and can take appropriate measures, for instance by restarting a cleaning cycle, after all draw-off taps 3 have been opened. Furthermore, a log of all cleaning cycles can be kept, so that at a later stage, it can be checked whether the cleaning operations have indeed been carried out properly.

As the sensor 73 is included in the rinsing line, this does not contact the beverage, so that contamination thereof is considerably reduced. Accordingly, in this embodiment, the sensor 73 does not come into contact with the rinsing liquid either because the sensor 73 is provided upstream of the non-return valve 61A. Furthermore, only one sensor is required for the entire line system. However, a flow sensor could also be included, for the same purpose, in another part of the line system 2, for instance in the tapping line 9, or in each of the sub-tapping lines 9A-D or one in each draw-off tap 3. With it, furthermore, the amount of beverage dispensed per draw-off tap could be determined, so that an even more accurate management is possible.

After cleaning agent has been fed through the line system 2 for a desired period of time, clean water is once more supplied, during a third period of time, from the water connection 15. As the capacity of the line system 2 is known, which capacity can be inputted into the system in advance, and the flow of the water is measured, the regulator unit can automatically establish whether all cleaning liquid has been displaced from the line system. Only then, the cleaning cycle can be terminated and the connecting head 6, 7 can again be brought in the desired position for tapping beverage. With the measuring device 74, it can be determined whether all cleaning agent has disappeared from the line system. It will be clear that with this, with minimum loss of beverage and great certainty, a cleaning cycle can be carried out safely, without a manager needing to uncouple any holder or keg or needing to perform other operations to kegs and/or holders. The interface, in particular the touch screen 79 can be arranged adjacent one of the draw-off taps 3 on for instance a bar, while the kegs 5 and/or holders 4 can be arranged in, for instance, a cellar space. Then, operation of the installation can take place from the bar. Preferably, the regulator unit is provided with communication means, preferably wireless communication means and telemetry means 80A. In each holder 4, a rest volume indicator, such as a degree of filling sensor 131 may be included, temperature sensors for the beverage and the cooling means 50 can be provided, connected to the regulator unit 52, and a sensor may be provided in the storage tank 63, also connected to the regulator unit 52. The regulator unit 54 can further be connected to an intranet, extranet or Internet or similar network. With it, the regulator unit 54 can communicate with, for instance, a computer or website of the manager, so that the manager can always be kept informed of the condition of his installation 1, preferably real time, the regulator unit can communicate with a logistic system of a brewer, beverage supplier or other supplier, so that each time, orders can be given simply and online, or the possibility can even be offered to give a supplier a signal, automatically generated by the regulator unit, if the stock of a particular product, such as beer, falls below a desired minimum level inputted into the regulator unit, so that this supplier can make a delivery suggestion or can plan a delivery. It is preferred that in the regulator unit also, an option is provided with which the manager and third parties may communicate, via, for instance, e-mail, training modules can be presented for staff for, for instance, maintenance of the installation, new products, actions of consumers and the like, a brewer or manager or third parties may pass on offers, and online billing can be enabled. On the basis of data collected in the regulator unit 52, a supplier may determine what the turnover has been over a particular preceding period and send a bill or charge an account. Also, a discount can be given with a particular minimum turnover, incentives can be offered via the regulator unit and other promotional and managerial activities can be deployed.

With an installation according to the invention, management can be fully automated and be regulated and carried out from a location adjacent a draw-off tap or at least remotely from the kegs and holders. The installation 1 is preferably of modular design, with the regulator unit preferably built up with the aid of connector technology, so that modules can be added as desired, depending on, for instance, the number of kegs and/or holders and/or other containers, the connecting heads used, cooling means, cleaning means and interfaces. Such technology is sufficiently known per se to the skilled person.

In particular when the kegs and/or holders 5, 4 are emptied sequentially, each time when a switch from a completely emptied or partly emptied keg or holder to a successive keg 5 or holder 4 is made, the beverage in an intermediate line 10 between the completely or partly emptied keg or holder and the successive keg or holder 5, 4 can be displaced through the supply, via the rinsing line 8, of an amount of water that corresponds to the volume of the respective intermediate line, thereby preventing stagnation of beverage in the respective line and, furthermore, waste of beverage.

FIGS. 5A and B show a holder with a part of the tapping device, the holder being provided with a light source.

In FIGS. 5A and B, a holder 120 is shown, provided with a light source 121 with which at least ultra violet light, UV, can be radiated. The holder 120 comprises a base 124. The holder 120 is formed for holding a part of a tapping device, for instance as described on the basis of FIGS. 1-4, in particular open parts of, for instance, a connecting device, tapping head or the like. Here, the holder 120 will be described on the basis of a similar tapping device or parts thereof, but is not limited to the use therein or therewith. As part to be placed in or on the holder 120, or at least on or in the basis 120 thereof such that it can be radiated with light from the light source 121, here, in FIGS. 5A and B, a connecting head 6 or 7 according to any one of the preceding Figures will be described, but the invention is not limited thereto.

In the exemplary embodiment shown, the basis 124 of the holder 120 comprises a cavity 125, substantially defined by a wall 126 and a bottom 127. The cavity 125 is adapted to a part 128 of the part 123, such that the part 128 can rest in the cavity 125. In the example shown, the part 128 comprises at least one exit 129 and/or entrance 130, through which, during normal use of the part 123, a fluid, in particular beverage, such as beer, can flow or can come into contact therewith in another manner such that contamination can occur, so that the micro climate can change and biological contamination may occur.

By radiating with UV light said part 123 and at least the part 128 that comes into contact with the fluid, bacteria are killed while the part 123 is inserted in and/or on said holder 120, for instance while the part 123 is brought in a position of rest.

In FIG. 5A, a holder 120 for a connecting head 7 is shown which connecting head can be a tapping head such as a handle tapping head to which a keg 5 can be connected. Furthermore, a beverage valve D and a gas valve G of a keg are, during use, operable with the aid of the connecting head 7. Such a connecting head 7 can for instance be a standard handle tapping head, supplied by, for instance, MicroMatic of Denmark, or can be as shown and described on the basis of FIGS. 3, 3A or 4. For instance a stub 88 can be radiated by the UV-light of the light source 121, whereby any bacteria that may be present in and/or around the stub 88 and passages terminating therein such as openings, channel 107, widening 109 and such parts are killed. In a comparable manner, naturally, other parts can be radiated to the same purpose.

During exchange of a keg 5, the connecting head 7 may be inserted into or on the holder 120 and the light source 121 is energized at least for some time with the connecting head 7 placed in or on the holder 120, such that UV light is radiated. As a result, it is ensured that the connecting head 7 can always be parked during exchange of a keg 5. As a further result, it is each time ensured that the part 128 of the tapping head 7 that contacts a keg 5 is cleaned, so that contamination of a new keg 5 is prevented.

In the holder 120, preferably, a switch 118 is provided, preferably a contact switch or approach switch, which is operated by placing the connecting head 7 in or removing it from the holder 120, for switching the light source 121 on and off. Thus, energy can be saved. Preferably, the switch 118 is screened off from the environment, for instance by a film, or by designing it as a film switch or switch known per se. Also, a part of the holder 120 can be movable and thus function as operating means for a switch 118. Naturally, for that matter, also a switch can be provided that is operated by a user himself. A circuit 118A such as an electronic or mechanical circuit can be provided for switching the light source off, for instance a preselected time after the part is taken from the holder. The light source can be a UV lamp but can also provide UV light in another manner, for instance through a suitable filter.

In FIG. 5B, an alternative embodiment of a holder 120 is shown, designed for use with a connecting head 7 for a tank 4, with which connecting head 7 or at least a part thereof beverage can be introduced into the tank 4 as well as be removed therefrom. In the example shown, the connecting head is divisible in at least a first tap 11, included in a line system, in particular a multi-way valve, and a second tap 13 included between the first tap 11 and the tank 4, such as for instance but not limited to what is shown in FIGS. 3 and 3A. By removing the first tap 11, the tank can be filled by a combined entrance and exit in the second tap 13. Here, the first tap 11 can be inserted temporarily into the holder 120 and be irradiated in an earlier described manner by UV-light from the light source 121. To that end, in the holder 120 a first cavity 125A is included. A second cavity 125B can be provided, in which the second tap 13 can be inserted, for instance when a bag 16 is exchanged in the tank 4, or in which one end of a filling hose (not shown) can be inserted for filling the tank 4. The second tap 13 can also comprise a combined entrance and exit. Such a holder 120 can also be formed for inserting therein other parts of the tapping apparatus that come into contact with the beverage for cleaning these, for instance a filling hose, coupling or the like. Naturally also, a holder 120 can be formed onto which such a part can be set, so that a light source 121 or at least light coming therefrom can radiate into a passage or opening.

It is preferred that with the aid of the regulating system, different levels of use and management can be set which can be protected separately by a code or key, for instance a PIN-code to be inputted with the aid of the touch screen. For instance access for users, such as bar staff, for tapping, or entering or providing general information, access to a manager for carrying out managerial operations and access for installers and the like for settings, maintenance and the like.

Preferably, the flow in the line system is measured in order to check whether this does not fall below the MFT, which is an indication of a blockage or a closed tap, and a through-flow volume is measured or calculated from the flow in order to ensure that sufficient rinsing liquid and, in particular, clean water has been fed through after rinsing liquid has been introduced into the lines and has, for instance, stood there for some time.

Conductivity measurement or another measurement can be used for determining the composition of the liquid in the line system, as additional check for the removal of all cleaning agent before tapping is resumed.

Optionally, to the cleaning agent, a coloring or another marker can be added, wherein a detector for the color or other marker can be provided instead of or in addition to the conductivity sensor, with which it can also be checked whether the line system contains clean water. The fact is that when said color or marker is no longer detected after rinsing with clean water, all cleaning agent has been displaced and tapping can be resumed.

The invention is not limited in any manner to the embodiments given in the introduction and description. Many variations thereon are possible within the framework of the invention as outlined by the claims.

For instance, other numbers of kegs and/or containers can be utilized, which may be included in parallel circuits. Also, other connecting heads and other types of containers can be connected to the line system 2. Also, a separate filling opening for the BIC can be provided, wherein the three- or multi-way valve or at least the connecting head may be directly coupled to the BIC.

1. An apparatus for dispensing beverage, comprising a line system and at least one draw-off tap and a connecting head connected to said line system, as well as a connecting piece provided with means for connection to said connecting head to be connected to a beverage holder, wherein the line system comprises at least one rinsing line and a dispensing line and the connecting head comprises at least one valve device for connecting the dispensing line to, at will:
the connecting piece, or at least to a holder, for fluid communication between a holder and the tapping line; or
the at least one rinsing line for fluid communication between the respective rinsing line and the dispensing line.

2. An apparatus according to claim 1, wherein the connecting head comprises a three-way or multi-way valve, and a shutoff, wherein the shutoff is operatively includable between the connecting piece and the three-way or multi-way valve.

3. An apparatus according to claim 1, wherein the connecting piece is substantially straight and has a relatively small length relative to its cross-section.

4. An apparatus according to claim 1, wherein the three-way or multi-way valve is further switchable into a position wherein a filling opening is connected to the connecting piece, or at least to the holder, for filling this.

5. An apparatus according to claim 1, wherein at least two connecting heads are provided, for connecting at least two holders to the line system, and preferably wherein an intermediate line is provided between the at least two connecting heads, which intermediate line, through operation of the connecting heads, can form part of the tapping line or of the rinsing line.

6. (canceled)

7. An apparatus according to claim 1, wherein at least two draw-off taps are provided connected to the tapping line.

8. An apparatus according to claim 1, wherein at least one holder is provided equipped as a cellar beer holder, in particular a bag-in-container type holder, wherein the connecting piece is insertable onto or into the holder, in particular into a neck of the bag.

9. An apparatus according to claim 1, wherein at least two holders are provided, connectable or connected to said line system, wherein the at least two holders are chosen to be different and are selected from the group of kegs, cellar beer holders with a content of at least 750 liters and bag-in-box containers with a content of less than 750 liters.

10. An apparatus according to claim 1, wherein the at least one connecting piece has a straight passage between a first and an opposite second end, wherein the first end is provided with a flange projecting outwards, which connecting piece is cleanable separately from the further apparatus.

11. An apparatus according to claim 1, wherein in and/or on the rinsing line, a flow measuring device is provided, preferably, viewed in flow direction of the rinsing line, in front of the first connecting head.

12. An apparatus according to claim 1, wherein a cleaning liquid holder and a cleaning liquid dosing device are provided, coupled to or couplable to the rinsing line.

13. An apparatus according to claim 1, wherein a pressure source, in particular an air pressure device is provided for operatively displacing beverage from a holder connected to the line system.

14. An apparatus according to claim 1, wherein an electronic regulator device is provided to which at least a flow meter provided in or on the rinsing line is connected, wherein the regulator device preferably comprises a display adjacent the at least one draw-off tap, such that a user of the draw-off tap can read said display, and preferably wherein the display is a touch screen, and preferably wherein a regulator device is provided which comprises an algorithm for carrying out an automatic cleaning program for the rinsing line and the dispensing line, wherein a flow meter is provided, connected to the regulator device, for measuring the flow through the rinsing line when said cleaning program is carried out, wherein in the regulator device at least a minimum threshold value is included and a comparator, such that if, when the cleaning program is carried out, the flow in the rinsing line is lower than said minimum threshold value, an alarm is produced, preferably via a display.

15. (canceled)

16. An apparatus according to claim 1, wherein the line system is provided with an inlet end remote from the at least one connecting head for letting in rinsing water, wherein the inlet end is provided with at least one inlet combination with at least one non-return valve.

17. An apparatus according to claim 1, wherein at least one cooling device is provided between the at least one connecting head and the at least one draw-off tap.

18. An apparatus according to claim 1, wherein a holder is provided in which beverage is included, wherein cooling means are provided for cooling said holder, which cooling means surround at least a connecting head connected to the holder.

19. (canceled)

20. An apparatus according to claim 1, wherein means are provided for measuring the beverage content of at least one holder connected to the line system, which means are preferably thermal measuring means, provided on a part of the holder.

21. An apparatus according to claim 1, wherein the apparatus is of modular design and comprises at least a line system provided with at least a tapping line and a rinsing line and a multi-way valve connected therebetween, wherein the apparatus comprises at least a tanking module, a regulating module, a cleaning module and a tapping module, said apparatus preferably further comprising a cooling module and/or pressure module, and preferably wherein the apparatus comprises a telemetry module, wherein preferably communication means are provided for communication between at least one user of the apparatus and a communication network such as Internet, intranet or internal network.

22-23. (canceled)

24. An apparatus according to claim 1, provided with a holder with a light source for radiating UV-light, wherein the holder can hold a part of a tapping device that, during normal use, comes into contact with a beverage to be dispensed by the tapping device, such that said part in and/or on the holder can be irradiated by light from said light source, preferably wherein the holder is provided with a switch for switching the light source on by placing said part in and/or on the holder, and preferably wherein the holder is provided with a circuit, in particular a time circuit for switching off the light source.

25-26. (canceled)

27. An apparatus according to claim 1, wherein the connecting head is connected to the beverage holder, wherein further a filling opening is provided for filling the beverage holder.

28. A method for use of a beverage dispensing apparatus, which comprises a cleaning line, a tapping line and a draw-off tap, wherein the cleaning line is coupled via a connecting head to the tapping line and to a holder for beverage, which connecting head comprises a three-way or multi-way valve and drive means therefor, which is drivable with the aid of a regulator device with operating means at a distance from the connecting head, wherein at the start of a cleaning cycle, the three-way or multi-way valve is brought from a first position, wherein the tapping line is in fluid communication with the holder, to a second position wherein the tapping line is in fluid communication with the cleaning line, while the at least one draw-off tap is opened and cleaning liquid is fed through the cleaning line through the connecting head, in particular through the three-way or multi-way valve into the tapping line, while displacing beverage from the tapping line through the draw-off tap, whereupon, then, during a first period, rinsing liquid is fed through the rinsing line and the tapping line, carried off via the at least one draw-off tap and after that, during a second period, water is led through the rinsing line and the tapping line, for removing the rinsing liquid from the tapping line, whereupon the at least one three-way or multi-way valve is returned to the first position and the draw-off tap is closed, whereupon water having remained behind in the tapping line is displaced from the tapping line with the aid of beverage from a holder connected to the three-way or multi-way valve, preferably wherein at least during the first period and preferably at least during the first and the second period flow in the cleaning line is measured, preferably wherein said cleaning cycle is automatically carried out with the aid of an algorithm in a control device, wherein a minimum threshold value is set for said flow and at least an alarm signal is produced when the measured flow falls below said minimum threshold value (MFT) during the first period and/or the second period, and preferably wherein, when the flow falls below the MFT, tapping of beverage is prevented.

29-31. (canceled)
